(19) United States
(12) Patent Application Publication
(10) Pub. No.: US 2013/0213281 A1
(43) Pub. Date: Aug. 22, 2013

(54) Refuse incineration plant and incineration exhaust filtration system and method for use therewith

(71) Applicants: Randel L. Havens, Elizabethtown, KY (US); Mark W. Kaufman, Dubuque, IA (US)

(72) Inventors: Randel L. Havens, Elizabethtown, KY (US); Mark W. Kaufman, Dubuque, IA (US)

(73) Assignee: SYNTURIAN ENTERPRISES, INC., Dubuque, IA (US)

(21) Appl. No.: 13/402,334

(22) Filed: Feb. 22, 2012

(51) Int. Cl. F23J 15/00; B03C 1/00

(52) U.S. Cl. 110/216; 96/2; 95/28

(57) ABSTRACT

A filter vessel for removing metal particles from exhaust, comprising a casing defining an internal chamber adapted to receive a flow of gas travelling along a flow direction; an electrostatic grid disposed in the internal chamber in intersecting relation to the flow direction, the electrostatic grid adapted to electrostatically charge metal particles in the flow of gas; a first electromagnet disposed on the casing in a downstream location along the flow direction relative to the electrostatic grid, the first electromagnet adapted to attract the electrostatically charged metal particles; a second electromagnet disposed on the casing in a downstream location along the flow direction relative to the first electromagnet, the second electromagnet adapted to attract the electrostatically charged metal particles; a controller configured to control the energization of the first and second electromagnets; and a metal particle collector for collecting electrostatically charged metal particles attracted by the first and second electromagnets.

### BACKGROUND

The instant disclosure relates to a refuse incineration plant and more particularly to incineration exhaust gas filtration systems for use therewith. Consumer and industrial refuse generation has reached an unprecedented level in the United States. Consumer consumption on the individual and family level combined with an increased amount of product packaging has raised the individual refuse generation volume to one of the highest levels in recorded history. To meet an increased consumer demand for products, industry has also increased their production which carries with it, as a natural byproduct, increased refuse generation at the manufacturer level as well.

At the same time that the refuse output of the population is increasing, the available space in current and proposed landfills is rapidly decreasing due to increased consumer demand for land and the volume of refuse placed in current landfills. As a result, much research and development activity has concentrated in the area of refuse management, and in particular on refuse incineration. Out of this research and development, various incineration systems have been patented, including those described in U.S. Pat. Nos. 3,467,587; 3,937,023; 3,965,362; 4,852,344; 4,896,508; 4,970,969; 5,127,344; and 5,678,420. While many of these systems are able to alleviate the pressing problems resulting from the increased refuse generation, most are primarily concerned with aspects of the incineration process that maximize the electric power generated from the heat produced during the incineration of the refuse. While energy production and utilization is an important byproduct and benefit of refuse incineration, many of these systems overlook the environmental impact caused by the smoke and exhaust resulting from the incineration of refuse as fuel for power generation. To prevent much of this impact, many of the refuse incineration plants currently in operation require that prior to the incineration of the refuse the different types of refuse be separated to remove various materials. This significantly increases the cost of refuse incineration, and tends to dissuade further investment in this technology.

The requirement for the separation of refuse stems from output emissions requirements and incinerator performance. Specifically, the output emissions filtration systems which are currently available and economically feasible simply cannot provide the required amount of filtration at an acceptable cost to allow the incineration of multiple types of refuse in a single incinerator. There exists therefore a need for an incineration plant which is capable of incinerating unsorted refuse while still meeting and exceeding the emissions requirements.

### SUMMARY

In view of the problems existing in the art, it is an object of the instant disclosure to provide a new and improved refuse incineration plant, and more specifically a new and improved refuse incineration plant that uses a filtration system which economically meets and exceeds the emissions requirements for refuse incineration plants. It is a further object of the instant disclosure to provide a refuse incineration plant which is capable of incinerating unsorted refuse, thus greatly reducing the overall costs of such incineration. It is a further object of the instant disclosure to provide a refuse incineration plant which uses the heat generated from the incineration process to produce electrical energy for distribution to the power grid. It is an additional object of the instant disclosure to provide a refuse incineration plant that produces as a byproduct of the incineration process a material which may be used instead of simply discarded.

It is also a feature of the instant disclosure to provide an incineration plant that uses a series of filter vessels that filter incineration exhaust to release only a low amount of pollutants into the atmosphere. It is a further feature of the instant disclosure that the filter vessels use a porous fill material to increase the surface area within the filter vessels to improve the efficiency thereof. It is also a feature of the instant disclosure that at least one of the filter vessels removes metal particles from the incineration exhaust. It is also contemplated that the metal particles removed from the incineration exhaust can be put to beneficial uses. It is also feature of the instant disclosure that the filter vessels use spray water mist to aid in the filtration process. Further, it is a feature of the instant disclosure to use vaporizers and collection plates for reducing the volume of water required for the filtration system and for collecting the precipitant material removed from the incineration exhaust by the filtration system.

Additionally, it is a feature of the instant disclosure to provide a post-incineration ash treatment subsystem. It is a further feature that the ash subsystem separates various materials from the residual ash for recycling.

In view of these objects and features of the instant disclosure, one embodiment of the incineration plant comprises a plurality of burn trays moving along burn tray rails. The burn trays are loaded with refuse, and are transported along the burn tray rails into and out of incineration chambers, and then to an ash removal area where the incinerated refuse is removed from the burn trays. Multiple burn trays may be used on a single track, with individual burn trays located at various locations thereon. Preferably, the plant of the instant disclosure includes multiple incineration chambers into which the refuse-loaded burn trays can be positioned for incineration of the refuse contained thereon. The burn trays are made of a high strength, heat resistant material capable of withstanding the incineration process. Preferably, the incineration chamber includes a burn core and doors on either end of the chamber to accommodate the insertion and extraction of the burn trays. Once a refuse-loaded burn tray has been positioned within the incineration chamber, air rams force air into the incineration chamber from both ends to aid in the incineration process. The heat energy generated within the incineration chamber is used in a fairly conventional steam-driven turbine to generate electricity.

Once the refuse has been fully incinerated, the burn tray is extracted from the opposite end of the incineration chamber and then travels along the burn tray rail to an ash removal bay. The ash removed from the burn trays is sorted or sifted to remove recyclable material such as glass. The non-recyclable ash may be used to make usable byproducts that may be used as a construction material that will not conduct electricity and can be waterproof. This treatment process may be controlled to produce a flexible or rigid byproduct for use in a variety of products including food trays, roof shingles, tiles, and countertops.

The output exhaust from the incineration process is preferably released into a main mixing vessel. Preferably, the main mixing vessel includes a secondary fume ignitor to burn off volatile gases and enhance the safety of the overall system. In an embodiment, a main mixing vessel includes a flow guide and water vapor spray jets to begin the initial precipitation of the exhaust pollutants. The exhaust preferably enters the bottom of the main mixing vessel and follows an exhaust flow path upward through the main mixing vessel to the top thereof. The main mixing vessel has an outlet exhaust conduit at its top, leading to a first filter vessel which provides a downward exhaust flow path through a porous material. Preferably, lava rock is used in the filter vessels because of its enhanced surface area due to its porous nature and because it is lightweight and capable of withstanding high temperatures. The first filter vessel is preferably coupled through an exhaust conduit to another filter vessel that uses an upward exhaust flow path, also through a porous material. Preferably, this upward-and-downward-flowing configuration repeats a number of times, depending upon the volume of exhaust to be filtered, and based upon the size of the incineration plant and the type of refuse incinerated. The water vapor that condenses in the filter vessels will be taken by return lines to vaporizing units which will vaporize the water and collect the particulate material on the vaporizing plates therein. This material may be cleaned from the vaporizing plates as necessary. The condensation of the exhaust and vapor mixture is also aided by the periodic placement of refrigeration coolers distributed throughout the exhaust filtration system.

Another embodiment of the instant disclosure comprises at least one incineration chamber containing a burn core, the incineration chamber having fore and aft doors. The burn core is suitable for incineration of refuse. Further, the refuse incineration plant includes a burn tray rail system that provides a track through the burn core and connects the burn core with a refuse loading area and an ash removal area within the plant. At least one burn tray is movably positioned on the burn tray rail system, and is adapted to carry refuse from the refuse loading area, through the burn core, and to the ash removal area all while on the rail system. One embodiment of the refuse incineration plant also includes an incineration exhaust filtration system having a main mixing vessel and a plurality of filter vessels in serial ascending/descending gaseous communication. In this embodiment, the rail system provides a continuous path from the refuse loading area, through the burn core, through the ash removal area, and back to the refuse loading area.

The plant of the instant disclosure may further provide an incineration exhaust sensor for sensing the exhaust produced by the operation of the burn core and providing an output to a burn cycle controller. Preferably, the burn cycle controller varies the period of operation of the burn core based on the input from the exhaust sensor. The exhaust sensor is preferably a light wave-type sensor that provides an output signal indicative of the amount of particulate matter in the exhaust. Further, the burn cycle controller preferably continues operation of the burn core until the output signal drops to a preset level corresponding to essentially complete incineration of the refuse within the burn core.

Both the fore and aft doors of the incineration chamber include air rams that provide increased airflow into the burn core to enhance its operation. In an embodiment having at least two burn cores and a steam-driven turbine power generation subsystem having its main steam vessel positioned in thermal association with the at least two burn cores, the burn cycle controller ensures that a burn cycle in one of the at least two burn cores does not start and end at the same time as a burn cycle in another of the burn cores.

In another embodiment, the system further comprises a cooling unit. In this embodiment, the main mixing vessel includes a vertical housing having an incineration exhaust entry port and a cold air entry port near the bottom of the main mixing vessel, and an incineration exhaust exit port at the top of the main mixing vessel. The incineration exhaust entry port is in gaseous communication with the burn core and the cold air entry port is in gaseous communication with the cooling unit. The main mixing vessel also includes a flow guide positioned within the vertical housing along its height and water vapor spray jets positioned around the inner periphery of the vertical housing. Preferably, the filter vessels have a vertical housing with a first exhaust port at a top thereof and a second exhaust port near a bottom thereof. The filter vessels further include condensation and filtration media disposed within the vertical housing, and a manifold area between an uppermost surface of the filtration media and a bottom surface of the top of the vertical housing. Lava rock may be used as the condensation and filtration media. The plant further comprises a water vaporization system, including at least one vaporizer, a first fluid communication output circuit coupled between the vaporizer and the plurality of water vapor spray jets in the main mixing vessel, and a second fluid communication input circuit coupled between the main mixing vessel and the filter vessels to the vaporizer. Preferably, the vaporizer vaporizes fluid delivered to it from the main mixing vessel and the filter vessels, collecting residue thereon from the main mixing vessel and the filter vessels for later removal and disposal.

Further in accordance with the teachings of the instant disclosure is an incineration plant adapted to incinerate refuse, the incineration plant including at least one burn core in which refuse is incinerated thereby generating smoke and exhaust, an incineration exhaust filtration system comprising a vertical main mixing vessel having an exhaust inlet port near a bottom thereof for receiving smoke and exhaust from the incineration plant. The vertical main mixing vessel further includes an exhaust outlet port at a top thereof. A flow guide is axially displaced within the main mixing vessel, and water vapor spray jets are disposed around an inner periphery of main mixing vessel. The system further comprises vertical filter condensation vessels coupled to the exhaust outlet port of main mixing vessel in series descending/ascending gaseous communication thereby forming an exhaust path of alternating descending and ascending gaseous flow through the adjacent, series-coupled filter vessels. Preferably, the system further comprises a cooling unit in gaseous communication with the main mixing vessel to supply cold air to be mixed with the smoke and exhaust from the incineration plant within the main mixing vessel. Additionally, an embodiment also includes at least one cooling unit in gaseous communication within the exhaust path of the filter vessels cooling and aiding the condensation of the descending and ascending gaseous flow therethrough.

In an embodiment, the filter vessels include filtration media disposed therein. Preferably, the filter vessels have a manifold formed between an inner top surface of the filter vessels and an upper surface of the filtration media. Within this manifold, cleaning solution spray jets disposed around an inner periphery form an acid ring and help clean the filtration media. Further, the main mixing vessel and filter vessels preferably include a condensed fluid drainage port in liquid communication with at least one vaporizer which provides water to the water vapor spray jets. Specifically, the vaporizer vaporizes water out of the condensed fluid thereby collecting residue therefrom. This residue is preferably periodically removed from the vaporizer. In an embodiment of the instant disclosure the system further comprises a secondary vertical filter vessel in series descending gaseous communication with the filter vessels, and a vertical filter and testing vessel in series ascending gaseous communication with said secondary filter vessel.

As a byproduct of the refuse incineration process, incineration exhaust may contain metal particles in aerosol solution. In yet another embodiment, at least one of the filter vessels of the incineration exhaust filtration system collects and removes metal particles from the incineration exhaust. To remove the metal particles from the incineration exhaust, the filter vessel has an electrostatic grid disposed within the filter vessel. The electrostatic grid is powered by an external power source, and charges the incineration exhaust with electrostatic energy. The incineration exhaust also passes through at least one flow guide that guides the incineration exhaust toward the periphery of the filter vessel. Next, the electrostatically charged exhaust encounters a series of electromagnets that are disposed around the inner periphery of the filter vessel. The electromagnets are energized in an alternating sequence to attract the metal particles within the electrostatically charged exhaust. As the electromagnets are energized and de-energized in alternating sequence, the metal particles attracted by the electromagnets are stepped down the inner periphery of the filter vessel toward the bottom of the filter vessel. At the bottom of the filter vessel another electromagnet alternates between an energized and de-energized state. When energized, the electromagnet attracts the electrostatically charged metal particles that have been stepped down the inner periphery of the filter vessel. The electromagnet can be disposed within the drainage conduit that also lies at the bottom of the filter vessel. The drainage conduit collects liquid that has condensed within the filter vessel, as well as the metal particles that have been stepped down by the electromagnets within the filter vessel. The collected metal particles accumulate in a metal particle collector. The collected metal particles can then be removed from the incineration exhaust filtration system and either discarded or put to some beneficial use.

In accordance with the teachings of the instant disclosure, a method of filtering exhaust from a refuse incineration plant comprises the steps of mixing the exhaust with water vapor, promoting condensation of the mixed exhaust and water vapor, recovering the condensed exhaust and water vapor, vaporizing water from the recovered condensed exhaust and water vapor, and removing the residue remaining after vaporization occurs. The step of promoting condensation comprises the steps of providing a series ascending/descending gaseous flow path, providing a high surface area filtration media within the series ascending/descending gaseous flow path, and reducing the temperature of the mixed exhaust and water vapor. Preferably, the step of mixing the exhaust with water vapor comprises the step of spraying water vapor into the ascending gaseous flow path at distributed points therealong within the main mixing vessel. In a particular embodiment of the instant disclosure, the step of mixing the exhaust with water vapor comprises the step of flowing the exhaust through a gaseous flow path including a flow guide placed therein, and spraying water vapor in the gaseous flow path. The method of filtering exhaust can also include the steps of electrostatically charging the exhaust, directing the flow of the electrostatically charged exhaust toward a series of electromagnets, alternating the energization and de-energization of the electromagnets to attract metal particles within the electrostatically charged exhaust, and collecting the metal particles attracted by the electromagnets, removing them from the exhaust.

These and other objects and advantages of the disclosure will become more apparent from the following detailed description when taken in conjunction with the accompanying drawings.

### BRIEF DESCRIPTION OF THE DRAWINGS

FIG. 1 is an overhead layout view of an incineration plant constructed in accordance with the teachings of the instant disclosure.

FIG. 2 is an isometric view of a burn tray suitable for use with the refuse incineration plant of the instant disclosure.

FIG. 3 is a partial cross-sectional view of an incineration plant and filtration system constructed in accordance with the teachings of the instant disclosure.

FIG. 4 is a schematic of the refuse incineration exhaust filtration system of the instant disclosure.

FIG. 5 shows the internal construction of one or more of the filter vessels of the instant disclosure in which exhaust flows in a generally downward direction.

FIG. 6 shows the internal construction of one or more of filter vessels of the instant disclosure in which exhaust flows in a generally upward direction.

FIG. 7 shows the internal construction of one or more of filter vessels of the present disclosure that is used to remove metal particles from the incineration exhaust.

FIG. 8 demonstrates the method of controlling the energization and de-energization of the electromagnets in the series of electromagnets of the present disclosure.

FIG. 9 demonstrates the method of controlling the energization and de-energization of the collector electromagnet of the present disclosure.

FIG. 10 demonstrates the method of filtering metal particles from incineration exhaust of the present disclosure.

While the disclosure will be described in connection with certain embodiments, there is no intent to limit it to those embodiments. On the contrary, the intent is to cover all alternatives, modifications and equivalents as included within the spirit and scope of the disclosure as defined by the appended claims.

### DETAILED DESCRIPTION

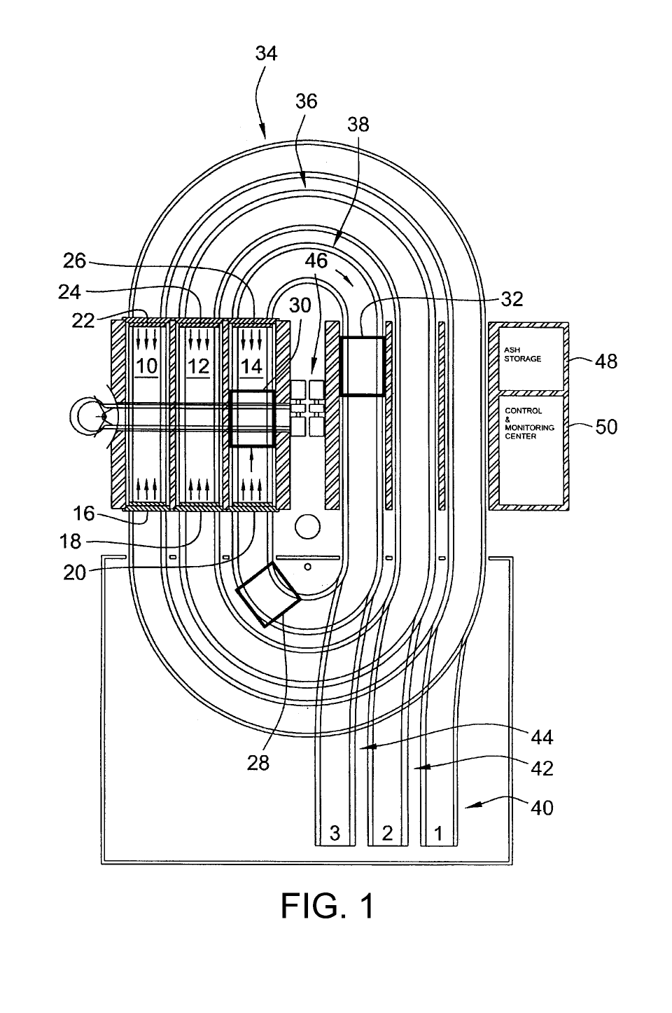

Referring to FIG. 1, in an embodiment of the instant disclosure, a refuse incineration plant includes three burn cores, 10, 12, and 14 in which refuse is incinerated. Burn cores 10, 12, and 14 each include a fore door 16, 18, 20 and an aft door 22, 24, 26, respectively. Fore doors 16, 18, and 20 and aft doors 22, 24, and 26 facilitate the insertion and extraction of the refuse to be incinerated in burn cores 10, 12, and 14 in a manner to increase the efficiency of the incineration plant. Refuse-holding burn trays can simultaneously be located in different locations within the incineration plant. For example, burn tray 28 may be loaded with refuse to be incinerated, while burn tray 30 is in burn core 14, while burn tray 32 is in the ash removal area. The movement of the burn trays through various stages of the incineration plant is facilitated through the use of burn tray rail circuits 34, 36, and 38. At least one burn tray rail circuit is associated with each burn core in the incineration plant. While FIG. 1 shows an oval burn tray rail circuit configuration, different plant layouts may dictate different burn tray rail circuit configurations. A continuous burn tray rail circuit system can help maximize system efficiency. As illustrated in FIG. 1, it is also contemplated that the burn tray rail circuit system may include spur rails 40, 42, and 44 to allow for burn tray replacement, loading, unloading, or other operations which may take an amount of time that would otherwise disrupt the continuous burn tray rail circuits 34, 36, and 38 of the instant disclosure.

While three burn tray rail circuits 34, 36, and 38 have been illustrated in association with three burn cores 10, 12, and 14, one skilled in the art will recognize that the particular number of burn cores and corresponding burn tray rail circuits for the transportation of the refuse burn trays may vary without departing from the spirit of the instant disclosure. Furthermore, as each of the individual burn core and burn tray rail circuit subsystems has a similar configuration, the following description will describe only the operation of a single burn core and a single burn tray rail circuit for simplicity. However, it is noted that discussion of a single burn core and burn tray rail circuit is meant for illustrative purposes and not for limiting the scope of the disclosure to the particular embodiment. Consequently, a multiple burn core embodiment will be described when such description aids in understanding the interaction between multiple burn cores and other aspects of the system.

As shown in FIG. 1, during operation of the incineration system of the instant disclosure, burn tray 28 is loaded with refuse in a refuse loading area through which the burn tray rail circuit 38 passes. Once loaded, burn tray 28 is transported along burn tray rail circuit 38 to burn core 14. Burn tray 28 is admitted to burn core 14 through fore door 20. Once the burn tray is in place in burn core 14, as shown by burn tray 30, fore door 20 is closed and the incineration process begins. During the incineration process, which may be of a conventional nature, air rams engage from both fore door 20 and aft door 26 to assist in the incineration process and to prevent exhaust leakage. A fuel assist may be used to aid in the incineration process. The temperature achieved in the burn cores may vary based upon the type of refuse incinerated, and may be between 800 and 1,400 degrees Fahrenheit. In addition to the variation in incineration temperature, the time that a burn tray is held in the burn core may also vary. Through the use of an exhaust sensor (described more fully below) the incineration process within the burn core continues until the exhaust sensor determines that the incineration process is complete. The exhaust sensor helps optimize incineration system efficiency as burn trays with different refuse compositions are in the burn core for no longer than is necessary to fully incinerate that particular composition of refuse. The entire incineration process is controlled and monitored from control and monitoring center 50, which includes a burn cycle controller that monitors the incineration process and controls its operation.

Once the incineration process is complete, aft door 26 is opened and burn tray 28 is transported along burn tray rail circuit 38 to an ash removal area. Once burn tray 28 exits burn core 14, aft door 26 closes and fore door 20 opens to accommodate the next refuse-loaded burn tray. The burn tray removal and insertion process described above is sequential in that aft door 26 closes before fore door 20 opens. The burn tray removal and insertion process may also be simultaneous, so that aft door 26 and fore door 20 open simultaneously and close simultaneously, permitting one incinerated burn tray leave the burn core at the same time another unincinerated burn tray enters. In a system that uses a small number of burn cores, the sequence is preferably sequential to maximize the retention of heat within the burn core. Even in a facility with a single burn core, the speed at which the spent burn tray may be extracted and a new tray inserted allows the burn core to produce enough heat to continuously operate a steam-driven turbine power generation subsystem 46. In a system with multiple burn cores, a simultaneous, as opposed to sequential, sequence of removal and insertion might be desired as other burn cores are likely to be in the incineration phase at the time any one burn core has completed its incineration phase and is engaging in an extraction and insertion operation. In this way, in a multiple burn core system, the heat from the burn cores which are operating in their incineration phases may provide the heat necessary to power steam-driven turbine power generation subsystem 46 to maintain full power output.

After exiting burn core 14, burn tray 28 travels along burn tray rail circuit 38 to an ash removal area. Burn tray 32 shows the placement of a burn tray in the ash removal area. In the ash removal area, the remaining ash and residue in the burn tray is removed, and the burn tray continues along its burn tray rail circuit 38 so that it may be reloaded with refuse for another cycle of the operation. Removal of ash may from the burn tray be accomplished in any number of conventional methods, and preferably is accomplished through the use of a wiper arm mechanism (not shown) that scrapes the incinerated refuse ash from the burn tray into ash removal bays located below burn tray rail circuit 38.

FIG. 2 provides a more detailed view of an exemplary burn tray. To assist ash removal, cage 90 is removed from burn tray frame 92 so that a wiper arm mechanism (not shown) may scrape away ash that has fallen through crossbars 100 of cage 90 into burn tray frame 92. Any large pieces of refuse remaining on cage 90 may be removed therefrom for further processing, or may be allowed to remain on cage 90 for reincineration. Once the ash and other residual material has been removed from the burn tray, the burn tray is transported by conveyer or other known mechanism to an ash sifting and sorting area where the ash is sifted through one or more filters. Material such as glass and metal may be removed from the ash in this area, and then transported to an appropriate recycling center for reuse. Referring again to FIG. 1., separated ash is stored in ash storage facility 48 which may contain several storage compartments for storage of different size ash particles. From ash storage area 48, refuse ash may be extracted for use in a post-incineration process to form a useful byproduct.

Referring again to FIG. 2, the burn trays of the instant disclosure are made of high strength heat resistant material. Burn tray 28 includes cage 90, which is suitable to hold the refuse in place while allowing fume and heat flow through the bottom grid of cage 90 to aid in the incineration of the refuse held therein. Cage 90 fits within a solid burn tray frame 92. Burn tray frame 92 includes wheels 94 mounted thereon for engagement with the burn tray rail circuit to allow transportation of the burn tray through the incineration system of the instant disclosure. Situated within the bottom of burn tray frame 92 is a plurality of burner assemblies 96 to aid in the incineration process. Burner assemblies 96 are configured along the length of burn tray frame 92 such that burner assembly upper surface 98 cooperates with crossbars 100 of cage 90 to form a lower grid pattern suitable for holding refuse in place during the incineration process. Burner assemblies 96 also include a plurality of flame ports 102 which interact with the fuel assist to help incinerate the refuse contained in burn tray 28. Flame ports 102 are preferably at least four inches from the bottom of burn tray frame 92. The relative position between flame ports 102 and burn tray 92 may vary so long as flame ports 102 do not become blocked by incinerated refuse ash that typically fills to the bottom of burn tray frame 92 during the incineration process.

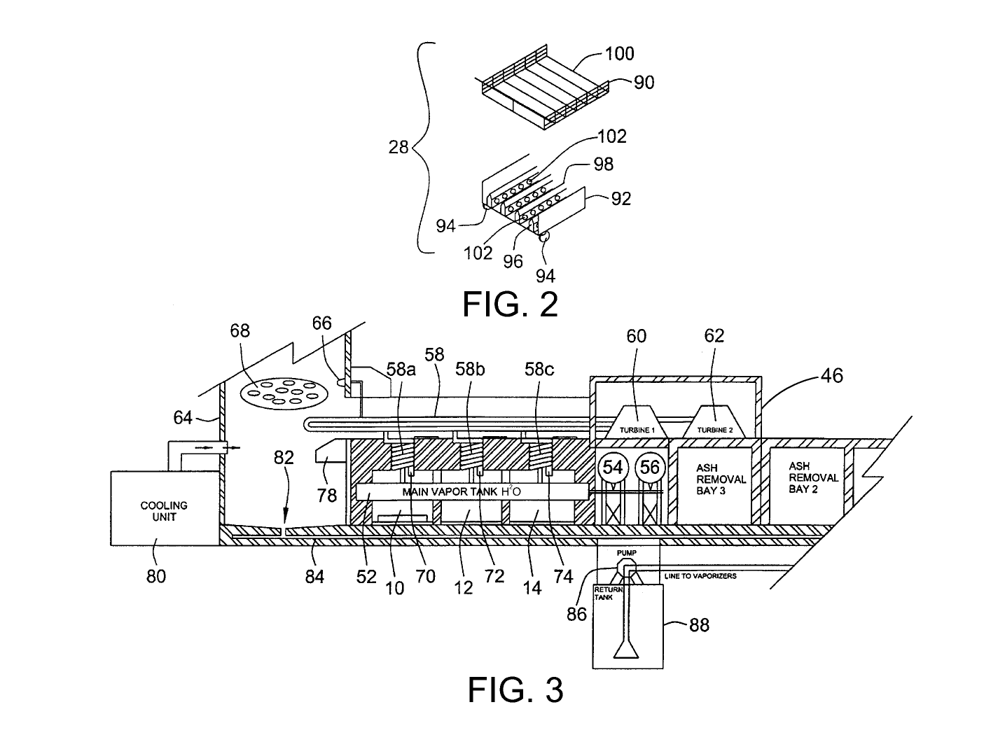

Referring to FIG. 3, which is a cross-sectional view of part of the incineration plant and filtration system, main vapor tank 52 of steam-driven turbine power generation subsystem 46 is positioned over individual burn cores 10, 12, and 14. Water is supplied to main vapor tank 52 from an external source, preferably from water storage vessels 54 and 56. Once in main vapor tank 52, the water is boiled by the heat emanating from burn cores 10, 12, and 14. The resulting steam is transferred through steam conduit 58 to drive steam turbines 60 and 62, which in turn drive multiple electric power generators (not shown) to produce electric power. The electric power may be used by the incineration plant and/or may be sold back into the power grid for distribution generation. Steam conduit 58 includes coils 58a, 58b, and 58c, which are positioned in the burn core exhaust flow path to maximize heating of the steam to optimize the power extracted therefrom. A portion of this superheated steam is diverted to main mixing vessel 64, into which the incineration exhaust flows. The steam is injected into main mixing vessel 64 through water vapor spray jets 66 located around an inner periphery of main mixing vessel 64, and in proximity to flow guide 68 located therein. Flow guide 68 will be described in more detail below.

Like steam coils 58a-c, exhaust sensors 70, 72, and 74 are also located in the exhaust path of burn cores 10, 12, 14 and determine when the incineration process in each burn core is complete. Exhaust sensors 70, 72, and 74 may be of light wave-type construction and capable of sensing the amount of smoke and other particulate matter contained in incineration exhaust. Instead of three separate exhaust sensors, a single exhaust sensor could be used to sense the combined exhaust produced by all the individual burn cores together, although using a single sensor would not allow metering of the individual burn cycle of each burn core. A single exhaust sensor could sense the combined exhaust if placed at the entrance to main mixing vessel 64. The output from exhaust sensors 70, 72, and 74 may be used by control and monitoring center 50 (shown in FIG. 1) to determine when it is appropriate to remove a burn tray from a burn core and replace it with a new burn tray loaded with refuse. Sensor output may be a discrete signal, which is used by an automated controller to advance the incineration process, or may be an output that indicates the amount of particulate matter in the exhaust, signaling the level of incineration cycle completeness. Additional sensors may be placed in the exhaust output to control other incineration parameters, such as incineration temperature, ram air flow, volume, or fuel assist level. These additional inputs would also be monitored by control and monitoring center 50.

Once incineration exhaust enters main mixing vessel 64, a secondary fume ignitor 78 ignites and burns off any volatile gases that may remain after incineration. Secondary fume ignitor 78 is used primarily as a safety measure against the accumulation of flammable or volatile gases in main mixing vessel 64 and the subsequent filter vessels. Once in main mixing vessel 64, incineration exhaust is mixed with cold air from cooling unit 80. The cold air reduces the temperature of the incineration exhaust and aids in the condensation of particulate matter from the incineration exhaust. To further aid in the condensation process, water vapor is sprayed into main mixing vessel 64 through water vapor spray jets 66 located about the inner periphery of main mixing vessel 64. Within main mixing vessel 64, flow guide 68 enhances the mixing of the water vapor and the incineration exhaust. Flow guide 68 may be a series of baffle plates positioned every five to ten feet up side of main mixing vessel 64, so that approximately at least four or five baffle plates are used to aid in the mixing.

As the particulate matter from the incineration exhaust gas mixes with the water vapor, condenses, and precipitates out of the vapor, it flows through collection port 82 in the bottom of main mixing vessel 64 and then through a precipitated liquid conduit 84 to return tank 88. Pump 86 takes the precipitated liquid mixture and delivers it to vaporizing units (now shown). The vaporizing units vaporize the water and recycle it to main mixing vessel 64 to be mixed again with the incineration exhaust, as described above, and to collect the precipitated residue. Periodically, the residue is removed from the vaporizer plates within the vaporizer units. The residue may then be disposed of or mixed with ash from the incineration process for further processing. Further description of the vaporization and vaporization unit cleaning process is included below.

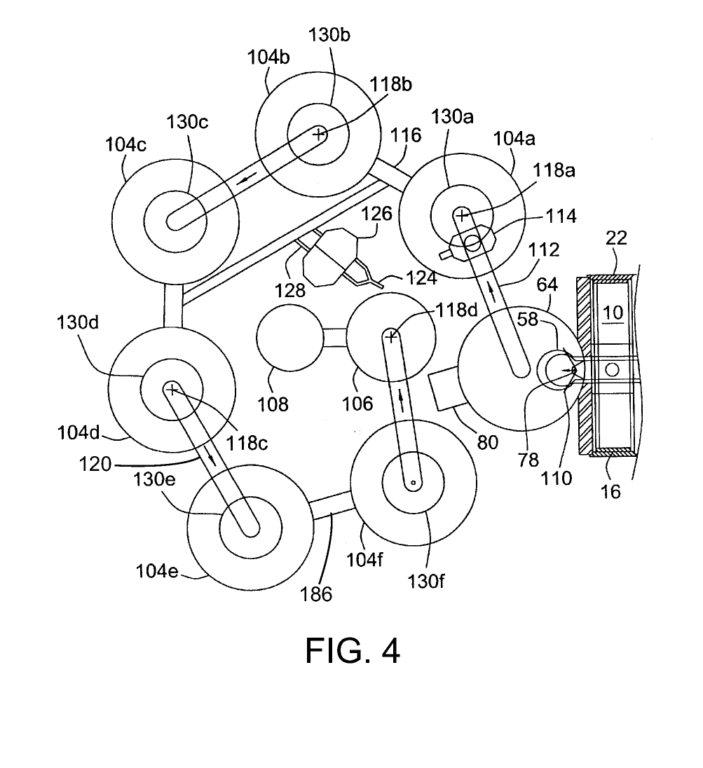

FIG. 4 shows the exhaust gas filtration system of the present disclosure. The filtration of the exhaust gas minimizes or eliminates the release of smoke and other pollutants into the atmosphere. The filtration system is optimally suited for the incineration system as described above, but one skilled in the art will recognize that this filtration system may also be used to improve the output emissions of other incineration plants. Further, by utilizing such a filtration system, incineration plants may increase the number of different types of refuse that may be incinerated therein due to the efficiency of the filtration system in removing smoke and other pollutants from output emissions.

The filtration system of FIG. 4 includes main mixing vessel 64, a series of filter vessels 104a-f, at least one secondary filter vessel 106, and a final filter and testing vessel 108. The system of filtration operates on a precipitation theory of filtration whereby the smoke and exhaust from the incineration process are mixed with water vapor within main mixing vessel 64 and allowed to condense into precipitation throughout filter vessels 104a-f, thereby removing smoke and other particulate matter from the incineration exhaust before it is released into the atmosphere. The precipitation process is aided within filter vessels 104a-f by the inclusion of a filtration material having a large surface area that promotes condensation.

The filtration process begins as the incineration exhaust represented by arrow 110 enters main mixing vessel 64 from burn core 110 and over secondary fume ignitor 78 (see FIG. 2 also). As described above, secondary fume ignitor 78 reduces the potential for volatile fume buildup within filter vessels 104a-f as a result of the incineration process. Once in main mixing vessel 64, incineration exhaust 110 is mixed with supercooled air from cooling unit 80. The supercooled air is rammed into main mixing vessel 64 to mix with the hot incineration exhaust to cool the resulting gaseous mixture and to promote condensation of the particulate matter contained therein. Incineration exhaust 110 is then drawn up through main mixing vessel 64. When incineration exhaust 110 flows up through main mixing vessel 64, it encounters a flow guide 68 (shown in FIG. 2) which aids in the mixing of incineration exhaust 110 with the water vapor supplied by water vapor spray jets 66 (also shown in FIG. 2) contained therein. Preferably, the baffle plates of the flow guide are spaced about every six feet along the height of main mixing vessel 64.

The portion of incineration exhaust 110 that is not condensed and precipitated out in main mixing vessel 64 travels through incineration exhaust conduit 112 to filter vessel 104a, the first in the series of filter vessels 104a-f. Cooling coil 118a is positioned within incineration exhaust conduit 112 at the top of filter vessel 104a to further cool incineration exhaust 110 and to aid in condensation. Similar cooling coils 118b-d are positioned throughout the system. Incineration exhaust 110 flows down through filter vessel 104a, aided by vacuum fan 114. The interiors of some of the filter vessels are filled with a highly porous material or other material having a large surface area that aids in the condensation and precipitation of particulate matter contained in incineration exhaust 110. Preferably, lava rock is used within the filter vessels 104a-f because it has a large surface area, is able to withstand high temperatures, and significantly enhances the condensation and precipitation of incineration exhaust 110. Glass beads having a large surface area may be used in place of lava rock.

The portion of incineration exhaust 110 which has not been mixed with water vapor and condensed out of the system travels next through incineration exhaust conduit 116 into filter vessel 104b where it flows upward therethrough. The construction of each of the filter vessels 104a-f is similar; however, the placement of vacuum fans to aid in the alternating downward-upward flow path of incineration exhaust 110 varies between the bottom and the top of the filter vessels as appropriate.

While the size of individual filter vessels 104a-f in the system may vary based upon system requirements, an embodiment of the instant disclosure uses thirty-foot diameter main mixing vessels and filter vessels, all having heights of approximately eighty feet. Preferably, these vessels are glass-fused. While a particular installation may call for specially manufactured filter vessels, an embodiment of the instant disclosure uses a Harvester™ silo manufactured by Smith Corporation of Janesville, Wis. Incineration exhaust conduits such as 112 and 116 preferably have a diameter of five feet. Secondary filter vessel 106 preferably has a diameter of twenty-two feet and a height of eighty feet. Final filter and testing vessel 108 may have a diameter of sixteen feet and a height of sixty feet. One skilled in the art will recognize that the particular diameter, heights, and shapes of the main mixing vessel 64 and all the filter vessels may vary based upon system requirements without departing from the spirit of the instant disclosure. The disclosure presents these construction parameters by way of illustration only and not by way of limitation. Furthermore, the number of filter vessels used may also vary based on system requirements.

Secondary filter vessel 106 need not be as large as filter vessels 104a-f due to the amount of condensation and precipitation which will already have occurred prior to incineration exhaust 110 reaching secondary filter vessel 106. As with filter vessels 104a-f, however, secondary filter vessel 106 includes cooling coil 118d to further reduce the temperature of incineration exhaust 110 and to enhance and promote additional condensation and precipitation of incineration exhaust 110 flowing therethrough. Final filter and testing vessel 108 also need not be as large as filter vessels 104a-f. By the time incineration exhaust 110 reaches final filter and testing vessel 108 and is then released into the atmosphere, its temperature is fairly low. The temperature may be in the range of approximately thirty-two to forty degrees Fahrenheit upon release into the atmosphere, and at times may be below freezing. Final filter and testing vessel 108 also includes a plurality of exhaust sensors therein (not shown) for performing tests ensure the system is not releasing pollutants into the atmosphere. These additional inputs would also be monitored by control and monitoring center 50. Other types of filters may be used in these vessels as appropriate.

Main mixing vessel 64 mixes a large amount of water vapor with incineration exhaust 110. After mixing occurs, the water vapor condenses in filter vessels 104a-f and precipitates to the bottom of these vessels as a liquid mixture. The liquid mixture is processed to limit the release of pollutants contained in the mixture into the environment. The liquid mixture is processed in an essentially closed liquid mixture circuit, which assists in vaporizing, collecting, and purifying the liquid mixture. Referring back to FIG. 4, each of filter vessel 104a-f includes a port to a liquid drainage conduit 128 which leads to vaporizing unit 126. Vaporizing unit 126 vaporizes the water and delivers it via vaporized water conduit 124 to water vapor spray jets 66 used in main mixing vessel 64 (shown in FIG. 3).

As the water vapor and incineration exhaust 110 mix within main mixing vessel 64, the water vapor condenses and precipitates to the bottom of main mixing vessel 64 and returns to vaporizer unit 126. Water vapor condensation, precipitation, collection, and return can also occur in filter vessels 104a-f. Within vaporizer unit 126, the water is vaporized and the particulate matter from main mixing vessel 64 and filter vessels 104a-f is collected. The collected particulate matter is periodically removed from vaporizer unit 126 and taken to a collection area where it may be mixed with the ash from the incineration process, or may be otherwise discarded. In this manner, incineration exhaust is mixed with water vapor, condensed into a liquid mixture, and then removed from the liquid mixture by vaporizing the water from the mixture leaving only solid residue.

During operation of the filtration system, incineration exhaust residue will be collected on the filtration media within filter vessels 104a-f. After time, the filtration media within filter vessels 104a-f may need to be cleaned to remove any residue buildup. When lava rock is used as the main filtration media, it may become necessary to remove residual buildup from the pores within the lava rock to maintain the condensation efficiency. Referring again to FIG. 4, an embodiment of the instant disclosure uses acid spray rings 130a-f within filter vessels 104a-f to remove residue from the filtration media. During the cleansing process, an acid-based material is sprayed by acid spray rings 130a-f over the filtration media to dissolve residue buildup. The acid-based material will be neutralized by the water within the system.

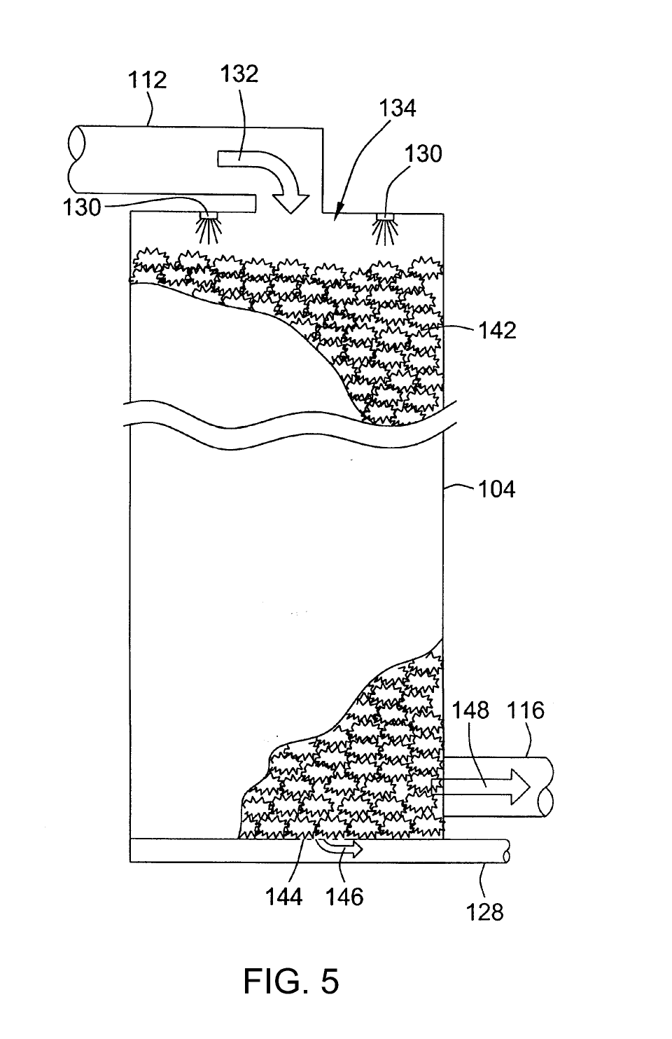

FIG. 5 shows the internal construction of one or more of filter vessels of the present disclosure in which exhaust flows in a generally downward direction. The shape of filter vessel 104 in FIG. 5 as well as the shapes of all vessels in the present disclosure are only intended to be illustrative. It would be appreciated by a person of ordinary skill in the art that the vessels of the present disclosure could be of many different shapes and sizes without departing from the spirit of the present disclosure. In FIG. 5, incineration exhaust, represented by arrow 132, enters filter vessel 104 through incineration exhaust conduit 112 and travels to manifold area 134. While in manifold area 134, incineration exhaust 132 is combined with water vapor emanating from water vapor sprayers 130. The combined mixture of incineration exhaust 132 and water vapor then flows down through filtration media 142 toward the bottom of filter vessel 104. During this process, a significant portion of incineration exhaust 132 and water vapor mixture condenses in filtration media 142 and precipitates to the bottom of filter vessel 104 in liquid form. The liquid then drains through liquid drainage port 144 and is returned via liquid drainage conduit 128 to vaporizing unit 126 as shown in FIG. 4. The flow of the drainage liquid is represented by arrow 146. The portion of the incineration exhaust and water vapor mixture that has not been condensed, represented by arrow 148, exits filter vessel 104 via incineration exhaust conduit 116 to be delivered to the next filter vessel in the filtration system.

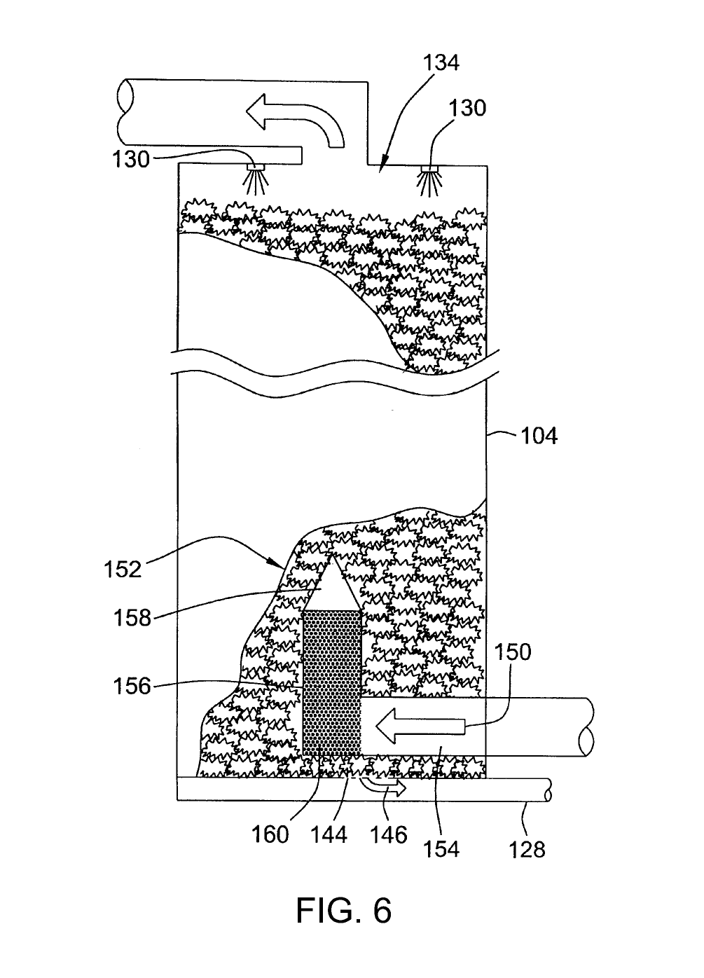

FIG. 6 shows the internal construction of one or more of filter vessels of the present disclosure in which exhaust flows in a generally upward direction. The construction of this filter vessel differs only slightly from that illustrated in FIG. 5. Incineration exhaust conduit 156 is comprised of horizontal segment 154, vertical segment 160, and conical cap 158. Incineration exhaust, represented by arrow 150, enters the bottom of filter vessel 104 through horizontal segment 154 and exits at the top of filter vessel 104. To help incineration exhaust 150 enter the main body of filter vessel 104, vertical segment 160 includes a plurality of ports around its periphery. The number, size, and placement of the ports may vary from their illustration in FIG. 6, so long as the flow of incineration exhaust 150 therethrough is not inhibited significantly. Conical cap 158 forces incineration exhaust 150 to exit the plurality of ports in vertical segment 160, and also directs precipitated material away from vertical segment 160. Horizontal segment 154 aids in the introduction of incineration exhaust 150 into filtration media 144, promoting condensation. Other structures may be employed for this purpose, including, for example, a manifold at the bottom of filter vessel 104 that is comprised of a mesh screen that prohibits filtration media 144 from entering incineration exhaust conduit 156.

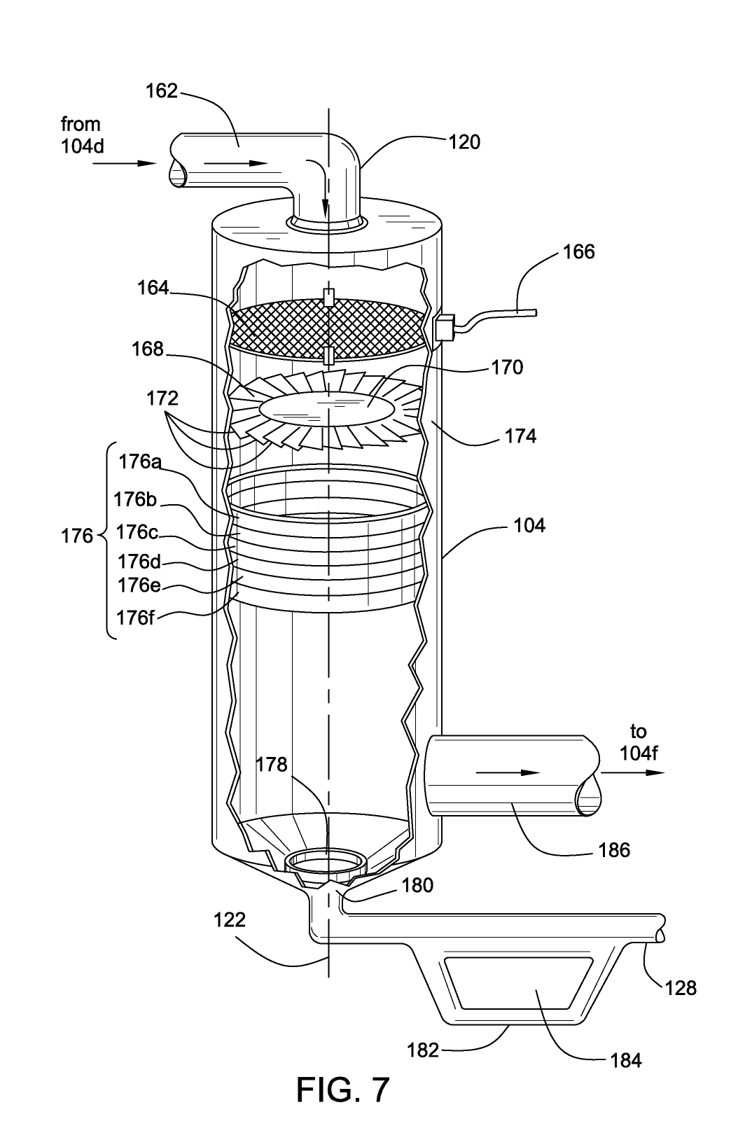

FIG. 7 shows the construction of one or more filter vessels of the present disclosure that is used to remove and collect metal particles that may be present in the incineration exhaust. Metal particles collected from the incineration exhaust may be put to beneficial use. For example, collected metal particles can be recycled or reused in another process or device within the refuse incineration plant. Collected metal particles can also be sold.

As shown in the partial sectional view of FIG. 7, filter vessel 104 has a casing 174. Filter vessel 104 is fluidly connected to the series of filter vessels 104a-f by incineration exhaust conduits 120 and 186, which carry the incineration exhaust, shown by arrow 162. In the illustrated embodiment, filter vessel 104 includes an electrostatic grid 164 extending orthogonally from a longitudinal dimension 122 of filter vessel 104 to casing 174. In this manner, electrostatic grid 164 is configured to intercept the flow of incineration exhaust 162 passing through filter vessel 104 from incineration exhaust conduit 162. Electrostatic grid 164 has a circular cross-section that cooperates with the generally cylindrical shape of filter vessel 104. It will be recognized by a person of ordinary skill in the art, however, that filter vessel 104 could be a shape different than that shown, and that electrostatic grid 164 should be positioned within filter vessel 104 to electrostatically charge incineration exhaust 162. Electrostatic grid 164 is powered through filter vessel power source 166.

In the illustrated embodiment, filter vessel 104 further includes a flow guide 168. Flow guide 168 may be any device used to direct flow. In the illustrated embodiment, flow guide 168 is a generally circular baffle plate that includes a plurality of pitched baffle veins 172 that help direct the flow of incineration exhaust 162. Flow guide 168 also includes closed portion 170 in its center that prevents incineration exhaust 162 from passing through the middle of flow guide 168 and instead forces incineration exhaust 162 to pass over pitched baffle veins 172. It will be appreciated that flow guide 168 is optional and could be of a different design, and that pitched baffle veins 172 may also be of a different design. It is also contemplated that the flow of incineration exhaust 162 may be directed within filter vessel 104 in a different fashion, such as through the use of a fan, a cone-shaped diffuser, or by any other known flow control device. Additionally, it should be recognized that flow guide 168 may be relocated so that incineration exhaust 162 passes through flow guide 168 prior to being electrostatically charged by electrostatic grid 164.

Filter vessel 104 also includes a series or plurality of electromagnets 176. Each electromagnet 176 is formed as a band extending circumferentially around the outer periphery of casing 174. The series of electromagnets 176 are stacked adjacent to one another along longitudinal dimension 122 of filter vessel 104. Series of electromagnets 176 may be located within or around the exterior of casing 174. In FIG. 7, series of electromagnets 176 includes six electromagnets 176a-f. It is contemplated that a different number of electromagnets and/or a different electromagnet configuration may be used. For example, individual magnets may be arranged in a line around a band of the casing 174. Alternatively, a series of electromagnets may be formed as a grid. The electromagnets in the series of electromagnets 176 may also be shaped differently than the bands shown in FIG. 7. Electromagnets 176a-f are powered through filter vessel power source 166. Energization and de-energization of electromagnets 176a-f is controlled by control and monitoring center 50 (shown in FIG. 1), which is configured to selectively transmit electrical current through windings (not shown) of each electromagnet.

The filter vessel 104 further includes a collecting electromagnet 178, which in the illustrated embodiment is located adjacent a bottom end of the filter vessel 104. Collecting electromagnet 178 may be, for example, ring- or band-shaped. Collecting electromagnet 178 is also controlled by control and monitoring center 50 and powered through filter vessel power source 166. Drainage port 180 is disposed in proximity to collecting electromagnet 178 and also near one extreme of the longitudinal dimension 122 of filter vessel 104. Drainage port 180 leads to liquid drainage conduit 128. A metal particle collector 182 is disposed along liquid drainage conduit 128. Metal particle collector 182 may be accessed through service panel 184. Incineration exhaust conduit 186 is also disposed near one extreme of the longitudinal dimension 122 of filter vessel 104 but generally prior to collecting electromagnet 178.

During operation, filter vessel 104 receives incineration exhaust 162 through incineration exhaust conduit 120. As a byproduct of the refuse incineration process, incineration exhaust 162 may contain metal particles in aerosol solution. To begin the process of separating the metal particles from incineration exhaust 162, incineration exhaust 162 is passed through electrostatic grid 164. Electrostatic grid 164 electrostatically charges the metal particles in incineration exhaust 162, allowing the metal particles to become drawn to electromagnets 176 disposed along longitudinal dimension 122 of filter vessel 104 as the stream of exhaust 162 passes through the electromagnets 176. In this respect, the flow guide 168 directs the exhaust 162 having the electrostatically charged metal particles exiting the grid 164 towards the electromagnets 176, and imparts a spiral trajectory to the metal particles found therein to prolong their flight time over the electromagnets. Electrostatic grid 164 is positioned within filter vessel 104 so as to ensure that at least a significant portion of incineration exhaust 162 is electrostatically charged.

When energized, electromagnets 176 attract the metal particles contained in electrostatically charged incineration exhaust 162. Disposing electromagnets 176 along longitudinal dimension 122 of filter vessel 104 increases the likelihood that metal particles will be attracted to the electromagnets and separated from incineration exhaust 162. Each electromagnet 176a-f in series of electromagnets 176 may be energized and de-energized independently of the others. By energizing and de-energizing each band sequentially in a downward direction along the filter vessel 104, metal particles captured on each band can be transferred from one band to the other in a downward direction in a step-wise fashion by force of gravity. To accomplish this transfer, electromagnets 176a-f are energized and de-energized in a manner to step attracted metal particles down longitudinal direction 122 within filter vessel 104.

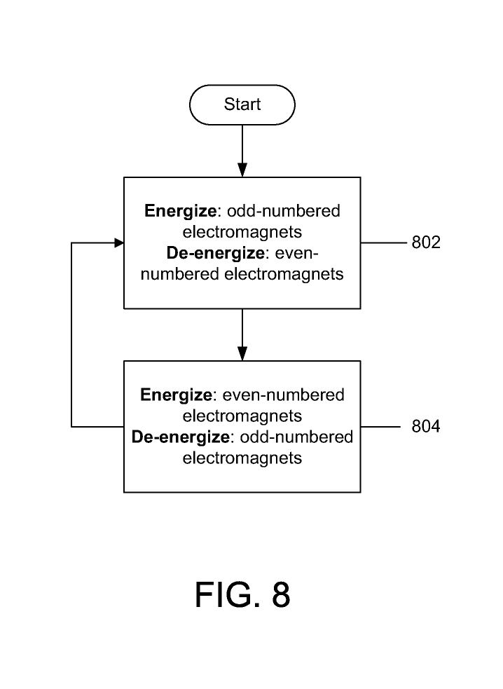

The stepping of metal particles down longitudinal dimension 122 of filter vessel 104 may be accomplished, for example, according the sequence described in FIG. 8, which includes alternate energizing of every other band. In this way, multiple bands are energized at any one time to increase the metal particle capturing capability of the system. At 802, odd-numbered electromagnets, such as electromagnets 176a, 176c, and 176e, are energized while even-numbered electromagnets, such as electromagnets 176b, 176d, and 176f, are de-energized. The energization of electromagnets 176a-f is then alternated. At 804, odd-numbered electromagnets, such as electromagnets 176a, 176c, and 176e, become de-energized, and even numbered-electromagnets, such as electromagnets 176b, 176d, and 176f, become energized. Cycling the energization of adjacent electromagnets allows metal particles initially attracted to electromagnet 176a to be stepped down to electromagnet 176b, and eventually over the entire series of electromagnets 176 to the last electromagnet in the series, electromagnet 176f. The time for which an electromagnet remains energized or de-energized may vary based on the amount of metal particles in the exhaust flow, the size of the filter vessel 104, the type of metal particles collected, and other factors, but it is contemplated that energization/de-energization will cycle approximately every ten minutes.

After attracted metal particles are stepped down longitudinal dimension 122 of filter vessel 104 via electromagnets 176, the metal particles are closer to the bottom of filter vessel 104. Collecting electromagnet 178, which is also located towards the bottom of filter vessel 104, attracts the metal particles stepped down by electromagnets 176 before those particles are carried off by the exhaust.

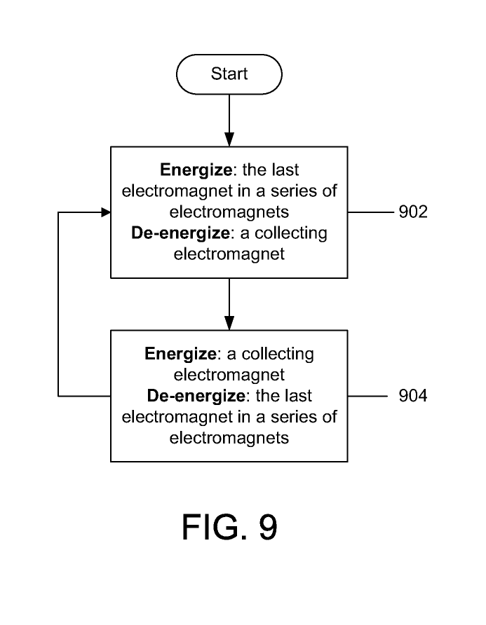

One embodiment of the energization/de-energization sequence of collecting electromagnet 178 is shown in FIG. 9. Collecting electromagnet 178 may be energized and de-energized in synchronization with electromagnets 176. More particularly, collecting electromagnet may be energized and de-energized on the opposite energization/de-energization cycle from the last electromagnet in the series of electromagnets 176. For example, at 902, the last electromagnet in a series of electromagnets, such as electromagnet 176f, is energized, while a collecting electromagnet, such as collecting electromagnet 178, is de-energized. Conversely, at 904, a collecting electromagnet, such as collecting electromagnet 178, is energized, while the last electromagnet in a series of electromagnets, such as electromagnet 176f, is de-energized. When controlled in this manner, metal particles attracted to electromagnet 176f are released from electromagnet 176f at approximately the same time collecting electromagnet 178 is energized, causing the metal particles to be passed from electromagnet 176f to collecting electromagnet 178. This process steps the metal particles down filter vessel 104. In an alternative embodiment, the collecting electromagnet 178 is energized for longer periods and is de-energized when a sufficient amount of metal particles has amassed on its surface.

Referring again to FIG. 7, when collecting electromagnet 178 is de-energized, the metal particles attracted thereon fall by force of gravity into drainage port 180, which also collects condensed liquid produced within the incineration exhaust filtration system. While not shown in FIG. 7, filter vessel 104 may also include its own vapor sprayer and condensation system, as previously described in connection with other filter vessels of the present disclosure. After passing into draining port 180, the metal particles are collected by metal particle collector 182, which is generally shaped as a catch basin. The metal particles collected in metal particle collector 182 fall to the bottom of the basin from where they can be collected and removed from the incineration exhaust filtration system, for example through service panel 184. Metal particle collector 182 may be of a different design than the collector shown in the illustrated embodiment. After the metal particles have precipitated, the condensed water collected by drainage port 180 continues through liquid drainage conduit 128 to the vaporizer unit 126 (shown in FIG. 4). The remaining portion of incineration exhaust 162, from which most or all metal particles have been removed, then passes to the next stage of the incineration exhaust filtration system through incineration exhaust conduit 186.

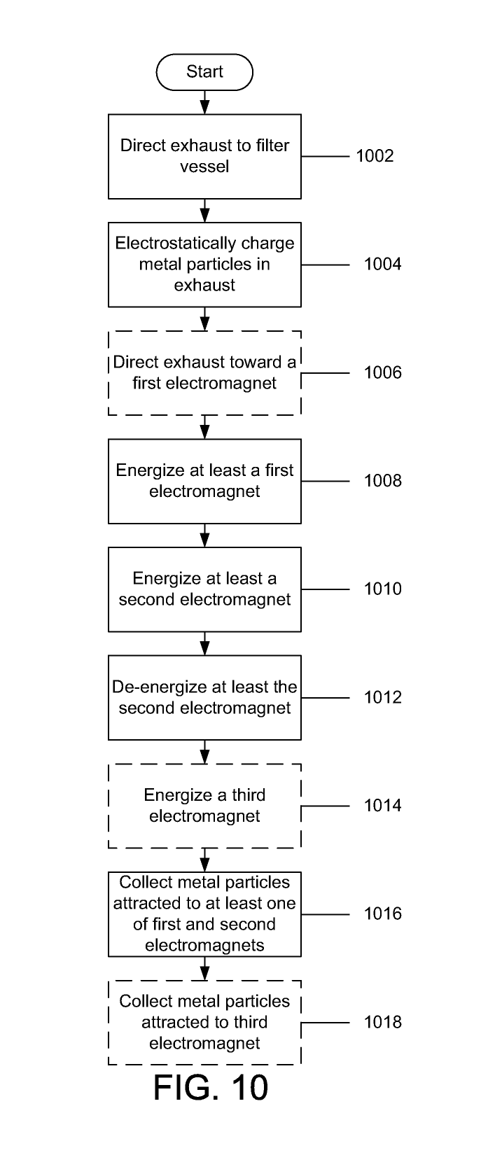

FIG. 10 illustrates a flowchart for a method of filtering metal particles from incineration exhaust in accordance with the present disclosure. In step 1002, incineration exhaust, such as incineration exhaust produced by a refuse incineration process, is directed to a filter vessel. The incineration exhaust is directed into the filter vessel though an incineration exhaust conduit. In step 1004, the metal particles in the incineration exhaust are electrostatically charged. Step 1004 can be accomplished through the use of an electrostatic grid that is powered by a filter vessel power source. After electrostatically charging the metal particles in the incineration exhaust, the incineration exhaust may be directed to a first electromagnet within the filter vessel, as shown by optional step 1006. Flow of the incineration exhaust may be guided toward the first electromagnet by, for example, a flow guide. In step 1008, at least the first electromagnet is energized. The first electromagnet may be a first electromagnet in a series of electromagnets where the series of electromagnets is disposed along the longitudinal dimension of the filter vessel or, stated differently, along a direction of flow of exhaust through the vessel. Energization of the first electromagnet and all other electromagnets associated with the filter vessel are controlled by a control and monitoring center. In step 1010, at least a second electromagnet is energized. The second electromagnet may be the next electromagnet in the series of electromagnets, or it may be a collector electromagnet located toward one extreme of the longitudinal dimension of the filter vessel. In step 1012, at least the second electromagnet is de-energized. De-energization of at least the second electromagnet allows metal particles attracted to at least the second electromagnet to be either attracted by a third electromagnet or to be collected for removal from the filter vessel.

The method for removing metal particles from incineration exhaust may also employ a third electromagnet, which, as shown in optional step 1014, may be energized after at least the second electromagnet is de-energized. In step 1016, the metal particles attracted to at least one of the first and second electromagnets are collected. If a third electromagnet is utilized, the metal particles attracted to the third electromagnet may also be collected, as shown in optional step 1018. The metal particles attracted to the electromagnets of the filter vessel may be collected in a metal particle collector and then removed from the filter vessel, effectively separating the metal particles from the incineration exhaust.

Although the illustrated embodiment for a filter vessel 104 (FIG. 7) includes a vertically oriented vessel, other configurations may be used. For example, a filter arrangement in which exhaust flow progressing in a horizontal or other direction is contemplated. In such embodiment, the electromagnetic bands may be replaced by electromagnetic bars arranged in a vertical stack and extending parallel to one another in a transverse direction relative to the flow of exhaust. The alternating activation and de-activation of adjacent bars can effectively collect metal particles and walk them by force of gravity towards a collector appropriately positioned beneath the electromagnet array.

The foregoing description of various embodiments of the disclosure has been presented for purposes of illustration and description. It is not intended to be exhaustive or to limit the disclosure to the precise forms described. Obvious modifications or variations are possible in light of the above teachings. The embodiments discussed were chosen and described to provide the best illustration of the principles of the disclosure and its practical application to thereby enable one of ordinary skill in the art to use the disclosure in various embodiments and with various modifications suited to the particular use contemplated. All such modifications and variations are within the scope of the disclosure as determined by the appended claims when interpreted in accordance with the breadth to which they are fairly, legally, and equitably entitled.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar referents in the context of describing the disclosure (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

1. A filter vessel for removing metal particles from exhaust, comprising:
a casing defining an internal chamber adapted to receive a flow of gas travelling along a flow direction;
an electrostatic grid disposed in the internal chamber in intersecting relation to the flow direction, the electrostatic grid adapted to electrostatically charge metal particles in the flow of gas;
a first electromagnet disposed on the casing in a downstream location along the flow direction relative to the electrostatic grid, the first electromagnet adapted to attract the electrostatically charged metal particles;
a second electromagnet disposed on the casing in a downstream location along the flow direction relative to the first electromagnet, the second electromagnet adapted to attract the electrostatically charged metal particles;
a controller configured to control the energization of the first and second electromagnets; and
a metal particle collector for collecting electrostatically charged metal particles attracted by the first and second electromagnets.

2. The filter vessel of claim 1, wherein the gas is exhaust produced by a refuse incineration plant.

3. The filter vessel of claim 1, further comprising a flow guide disposed in the casing in intersecting relation to the flow direction and at a location upstream along the flow direction relative to the first electromagnet.

4. The filter vessel of claim 3, wherein the flow guide is adapted to guide the flow of gas toward the first electromagnet.

5. The filter vessel of claim 4, wherein the flow guide is a plate having baffles.

6. The filter vessel of claim 3, wherein the flow guide is a plate having flow-directing baffles.

7. The filter vessel of claim 1, wherein the first electromagnet is one of a series of electromagnets arranged along a longitudinal dimension of the filter vessel along the flow direction.

8. The filter vessel of claim 1, wherein the controller is configured to alternate an energization state of the first and second electromagnets such that electrostatically charged metal particles attracted to the first electromagnet are released and attracted to the second electromagnet.

9. The filter vessel of claim 7, wherein the controller controls the energization of the electromagnets in the series of electromagnets.

10. The filter vessel of claim 9, wherein, in the series of electromagnets, each energized magnet is adjacent to at least one de-energized electromagnet during operation.

11. A refuse incineration plant, comprising:
at least one burn core for incinerating refuse; and
an exhaust filtration system that collects a flow of gas produced by the burn core, the exhaust filtration system comprising:
at least one filter vessel that receives the flow of gas, said filter vessel having a casing defining an internal chamber adapted to receive the flow of gas travelling along a flow direction; an electrostatic grid disposed in the internal chamber in intersecting relation to the flow direction, the electrostatic grid adapted to electrostatically charge metal particles in the flow of gas; a first electromagnet disposed on the casing in a downstream location along the flow direction relative to the electrostatic grid, the first electromagnet adapted to attract the electrostatically charged metal particles; a second electromagnet disposed on the casing in a downstream location along the flow direction relative to the first electromagnet, the second electromagnet adapted to attract the electrostatically charged metal particles; a controller configured to control the energization of the first and second electromagnets; and a metal particle collector for collecting electrostatically charged metal particles attracted by the first and second electromagnets.

12. The refuse incineration plant of claim 11, wherein the exhaust filtration system further comprises a main mixing vessel that receives the flow of gas from the at least one burn core; and a plurality of filter vessels in serial ascending-descending gaseous communication that receives the flow of gas from the main mixing vessel, said plurality of filter vessels having condensation and filtration media disposed therein.

13. The refuse incineration plant of claim 11, wherein the first electromagnet is one of a series of electromagnets arranged along a longitudinal dimension of the at least one filter vessel along the flow direction.

14. The refuse incineration plant of claim 13, wherein the controller is configured to alternate an energization state of the electromagnets in the series of electromagnets such that electrostatically charged metal particles attracted to the first electromagnet are released and attracted to another electromagnet in the series of electromagnets.

15. The refuse incineration plant of claim 14, wherein the controller is configured to alternate an energization state of the electromagnets in the series of electromagnets and of the second electromagnet such that electrostatically charged metal particles attracted to electromagnets in the series of electromagnets are released and attracted to the second electromagnet.

16. A method of removing metal particles from exhaust, comprising:
directing a flow of gas to at least one filter vessel;
electrostatically charging metal particles in the flow of gas;
energizing at least a first electromagnet to attract the electrostatically charged metal particles;
energizing at least a second electromagnet;
de-energizing at least the second electromagnet; and
collecting the electrostatically charged metal particles attracted to at least one of the first and second electromagnets.

17. The method of claim 16, further comprising energizing a third electromagnet after de-energizing the second electromagnet.

18. The method of claim 17, further comprising collecting the electrostatically charged metal particles attracted to the third electromagnet.

19. The method of claim 18, further comprising directing the flow of gas toward the first electromagnet after electrostatically charging the metal particles in the flow of gas.

20. The method of claim 16, further comprising directing the flow of gas toward the first electromagnet after electrostatically charging the metal particles in the flow of gas.
